(19) United States
(12) Patent Application Publication
(10) Pub. No.: US 2017/0164787 A1
(43) Pub. Date: Jun. 15, 2017

(54) COOKING SYSTEM

(71) Applicant: Christopher Edwards FRERET, Mandeville, LA (US)

(72) Inventor: Christopher Edwards FRERET, Mandeville, LA (US)

(21) Appl. No.: 14/968,368

(22) Filed: Dec. 14, 2015

(51) Int. Cl. A47J 44/00; F24B 3/00; A47J 37/12; A47J 27/04; A47J 37/07; F24B 1/26; F24C 11/00

(52) U.S. Cl. CPC A47J 44/00; F24B 1/26; F24B 3/00; F24C 11/00; A47J 27/04; A47J 37/0704; A47J 37/0786; A47J 37/1219; A47J 37/128; A47J 2027/043; A47J 2037/0795

(57) ABSTRACT

A cooking system providing eight different cooking methods through one cooking device is provided. The cooking device has a plurality of walls forming an enclosure space therein, wherein the enclosure space is accessible by an opening. The lower portion of the cooking device has adjustable heating elements for enabling the enclosure space to be used as a boiler pot, steamer pot or low heat simmer stew pot. The enclosure space is also adapted to removably, separately and operably retain a charcoal liner, a deep fryer basket, or a Cajun microwave, thereby embodying a method for providing at least eight different cooking methods through the cooking device.

### BACKGROUND OF THE INVENTION

The present invention relates to cooking devices and, more particularly, to a cooking system providing eight different cooking methods through one overall device.

Currently, those looking to perform the cooking methods of boiling, steaming, frying, stewing, grilling, smoking, Cajun microwaving, and griddling would need to procure a plurality of cooking devices providing at least a boiler, steamer, fryer, stew pot, charcoal grill, smoker, Cajun microwave and griddle. Clearly, procuring all of the above-mentioned cooking devices would be burdensome on the user's storage space as well as their wallet.

As can be seen, there is a need for a cooking system providing eight different cooking methods through one overall device.

### SUMMARY OF THE INVENTION

In one aspect of the present invention, a cooking system provides a plurality of cooking methods through a cooking device having a plurality of walls, wherein the plurality of walls define an enclosure space and an opening thereto; a lid movable between a closed configuration thermally sealing the opening, and an open configuration wherein the lid is disposed adjacent to the opening; and a hinge pivotally connecting the lid to at least one of the plurality of walls; and a Cajun microwave dimensioned and adapted to be supported along a periphery of the opening, whereby the enclosure space is adapted to be at least one of a boiler pot, a steamer pot or a low heat simmer stew pot.

In another aspect of the present invention, the cooking system includes a deep fryer basket having a plurality of hooks, wherein the plurality of hooks are adapted to pivot the deep fryer basket about the hinge between a frying configuration and a dumping configuration disposed adjacent to and above the lid in the open configuration.

In yet another aspect of the present invention, the cooking system includes a charcoal liner adapted to charcoal grill or smoke food stuff, wherein the enclosed space is dimensioned and adapted to support the charcoal liner.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in an exemplary of a closed configuration;

FIG. 2 is a detail perspective view of an exemplary embodiment of the present invention, demonstrating an exemplary unlocked horizontal state;

FIG. 3 is a detail perspective view of an exemplary embodiment of the present invention, demonstrating an exemplary locked vertical state;

FIG. 4 is a perspective detail view of an exemplary embodiment of the present invention, shown in an exemplary open configuration;

FIG. 5 is an exploded detail view of an exemplary embodiment of the present invention;

FIG. 6 is a top perspective view of an exemplary embodiment of the present invention;

FIG. 7 is an exploded detail view of an exemplary embodiment of the present invention;

FIG. 8 is a top perspective view of an exemplary embodiment of the present invention;

FIG. 9 is a top perspective view of an exemplary embodiment of the present invention, demonstrating rotation of an exemplary basket;

FIG. 10 is an exploded detail view of an exemplary embodiment of the present invention; and

FIG. 11 is a top perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cooking system providing eight different cooking methods through one cooking device. The cooking device has a plurality of walls forming an enclosure space therein, wherein the enclosure space is accessible by an opening. The lower portion of the cooking device has adjustable heating elements for enabling the enclosure space to be used as a boiler pot, steamer pot or low heat simmer stew pot. The enclosure space is also adapted to removably, separately and operably retain a charcoal liner, a deep fryer basket, or a Cajun microwave, thereby embodying a method for providing at least eight different cooking methods through the cooking device.

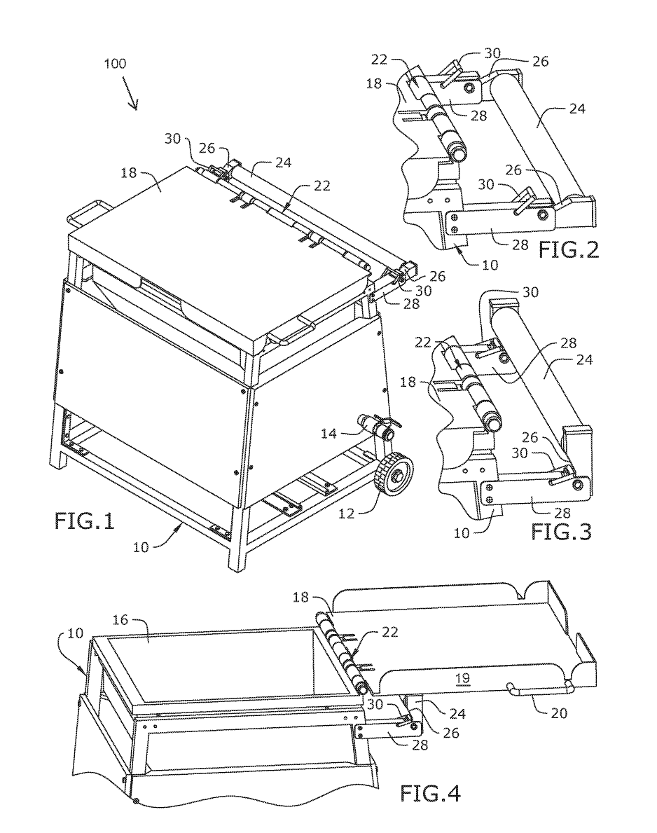

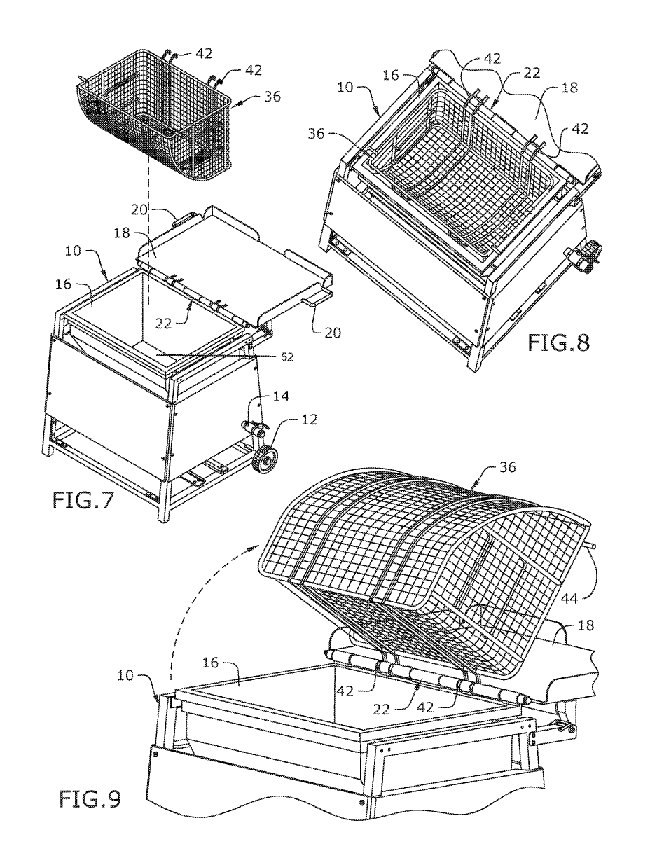

Referring to FIGS. 1 through 11, the present invention may include a cooking system 100 adapted to provide a boiler, steamer, fryer, stew pot, charcoal grill, smoker, Cajun microwave and griddle through a cooking device 10. The cooking device 10 may provide a plurality of walls forming an enclosure space 50 therein, wherein the enclosure space 50 is accessible by an opening 16.

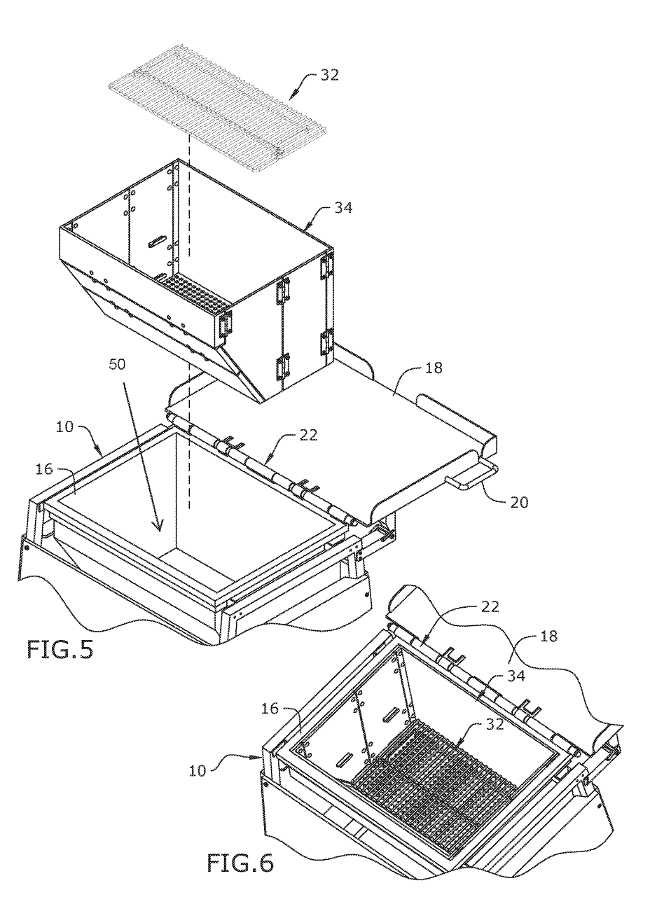

The cooking device 10 may provide a lid 18 pivotally connected by a hinge 22 along a periphery of the opening 16 so as to be movable between a closed configuration thermally sealing the opening 16, and an open configuration wherein an underside of the lid 18 is disposed parallel and adjacent to the opening 16, as illustrated in FIGS. 1 and 4, respectively. The lid 18 may provide lid handles 20 for manually moving the lid 18 between the open and closed configurations. The lid 18 may provide perimeter flanges 19 so that in the open configuration, the perimeter flanges 19 extend generally upwardly, thereby providing a barrier against any food or cooking item disposed on the upward facing underside of the lid 18 from slide thereoff.

The cooking device 10 may provide a set of wheels 12 for rolling the cooking device 10 between storage space(s) and operation space(s). The cooking device 10 may provide a roll bar 24 spaced away from at least one of the plurality of walls by a pair of brackets 28. The roll bar 24 may extend between and be rotatably connected to the pair of brackets 28 so as to be positioned between a vertical state for supporting the lid 18 in the open configuration, and a horizontal state for rolling the cooking device 10, as illustrated in FIGS. 4 and 2, respectively. The roll bar 24 may provide lock notches 26 and lock rings 30 for locking the roll bar 24 in the vertical state, as illustrated in FIG. 3.

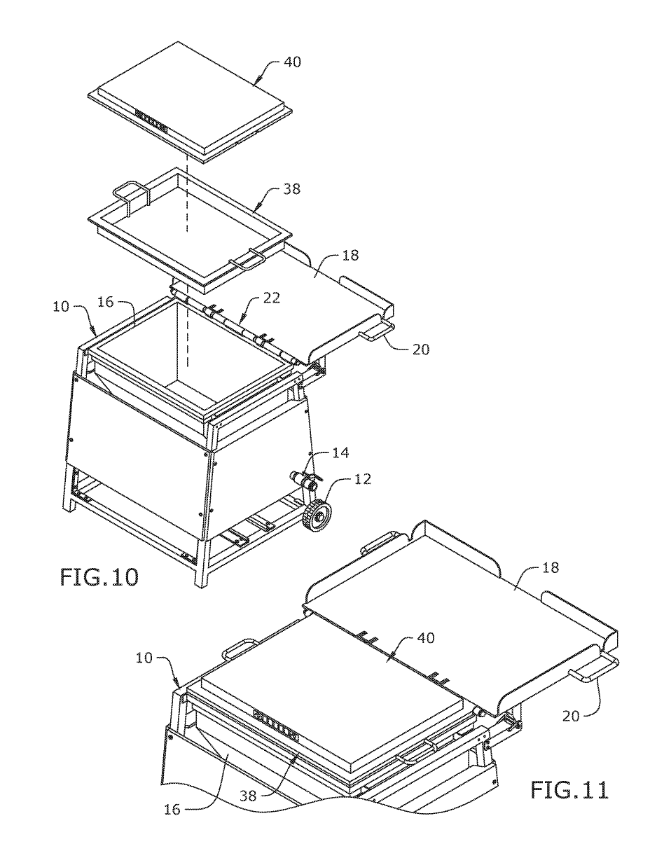

A lower portion 52 of the cooking device 10 may provide adjustable heating elements (not shown) for appropriately heating the enclosure space 50 as a boiler pot, a steamer pot or a low heat simmer stew pot. The heating elements(s) may include inserts for natural gas burner plates that may be disposed along the lower portion 52. In certain embodiments, the heating element(s) may be propane or charcoal sources. The enclosure space 50 may be dimensioned and adapted to removably and separately retain a charcoal liner 34, a basket 36, and a Cajun microwave 38 therein. The Cajun microwave 38 may be dimensioned and adapted to be secured about the periphery the opening 16, wherein the Cajun microwave 38 protrudes into a portion of the enclosure space 50, as illustrated in FIGS. 10 and 11. The Cajun microwave 38 may include a Cajun microwave lid 40 for operatively enclosing a Cajun microwaving space afforded by the Cajun microwave 38.

The charcoal liner 34 may be adapted to charcoal grill or smoke food stuff. The charcoal liner 34 may sit in the enclosure space 50. The charcoal liner 34 may provide a plurality of grill walls forming a grilling space adapted to house charcoal and a grill grate 32 for grilling food items thereon. The plurality of grill walls may form a plurality of vertically spaced apertures for selectively receiving a portion grill grate 32 so that it may be selectively position along a depth of the grilling space.

The basket 36 may be pivotally connected to the hinge 22 by basket hooks 42 so that the basket is movable between a frying configuration for submerging food stuff in the basket in a layer of hot fat, grease or oil on the lower portion 52 of the enclosure space 50, to a dumping configuration for dumping the food stuff in the basket onto the lid 18 in the open configuration, as illustrated in FIGS. 8 and 10, respectively. The cooking device 10 may also provide an external grease valve outlet 14 fluidly communicating with the lower portion 52 of the enclosure space 50 subsequent deep frying.

A method of using the present invention may include the following. The cooking system 100 disclosed above may be provided. By manipulating the roll bar 24, a user may roll the cooking device 10 from a storage space to an operational space. Then the user may choose which cooking method is immediately necessary and accordingly configure the cooking device 10 and associated components for providing the necessary cooking method. Then the user may either re-configure the cooking device 10 for a different cooking method or roll the cooking device 10 back to the storage space.

It should be understood, of course, that the foregoing relates to exemplary embodiments of the invention and that modifications may be made without departing from the spirit and scope of the invention as set forth in the following claims.

What is claimed is:

1. A cooking system adapted to provide a plurality of cooking methods, comprising:
a cooking device having a plurality of walls, wherein the plurality of walls define an enclosure space and an opening thereto;
a lid movable between a closed configuration thermally sealing the opening, and an open configuration wherein the lid is disposed adjacent to the opening; and
a hinge pivotally connecting the lid to at least one of the plurality of walls; and
a Cajun microwave dimensioned and adapted to be supported along a periphery of the opening,
whereby the enclosure space is adapted to be at least one of a boiler pot, a steamer pot or a low heat simmer stew pot.

2. The cooking system of claim 1, further providing a deep fryer basket having a plurality of hooks, wherein the plurality of hooks are adapted to pivot the deep fryer basket about the hinge between a frying configuration and a dumping configuration disposed adjacent to and above the lid in the open configuration.

3. The cooking system of claim 2, further comprising a charcoal liner adapted to charcoal grill or smoke food stuff, wherein the enclosed space is dimensioned and adapted to support the charcoal liner.

4. The cooking system of claim 3, further comprising a grill grate adapted to be selectively positioned along a depth of the charcoal liner.

5. The cooking system of claim 4, further comprising a set of wheels attached to the cooking device.

6. The cooking system of claim 5, further comprising a roll bar spaced away from the at least one of the plurality of walls by a pair of brackets, wherein the roll bar is movable between a vertical state for supporting the lid in the open configuration, and a horizontal state for rolling the cooking device by the set of wheels.

7. The cooking system of claim 6, further comprising a lock notch and a lock ring for each bracket of the pair of brackets, wherein each lock notch and lock ring are adapted to lock the roll bar in the vertical state.

8. The cooking system of claim 7, further comprising a plurality of perimeter flanges perpendicularly joined along a perimeter of an underside of the lid.

9. The cooking system of claim 8, further comprising a grease valve outlet fluidly communicating with a lower portion of the enclosure space.
